(19) United States
(12) Patent Application Publication
(10) Pub. No.: US 2023/0024245 A1
(43) Pub. Date: Jan. 26, 2023

(54) CONTAMINATION PROTECTION FOR RIBLET FILMS

(71) Applicant: Lufthansa Technik AG, Hamburg (DE)

(72) Inventors: Oliver Oeser, Borstel-Hohenraden (DE); Dirk Trottnow, Sahms (DE)

(21) Appl. No.: 17/785,404

(22) PCT Filed: Dec. 16, 2020
(86) PCT No.: PCT/EP2020/086401

§ 371 Date: Jun. 15, 2022

(30) Foreign Application Priority Data
Dec. 19, 2019 (DE) 10 2019 135 084.0

(51) Int. Cl. B64C 21/10; B64F 5/10; F15D 1/00

(52) U.S. Cl. CPC B64C 21/10; B64F 5/10; F15D 1/0035; B64C 2230/26

(57) ABSTRACT

A contamination protection is for edges of a riblet film, which is adhesively bonded to a surface. The riblet film has riblets formed on an upper side of a film layer, and an adhesive layer at a lower side of the film layer. The contamination protection has: an edge protection. The edge protection is formed directly on the riblet film that is adhesively bonded to the surface in such a manner that the edge protection covers the adhesive layer of the riblet film, but does not protrude over the upper side of the riblet film.

### CROSS REFERENCE TO RELATED APPLICATIONS

This application is a U.S. National Phase application under 35 U.S.C. § 371 of International Application No. PCT/EP2020/086401, filed on Dec. 16, 2020, and claims benefit to German Patent Application No. DE 10 2019 135 084.0, filed on Dec. 19, 2019. The International Application was published in German on Jun. 24, 2021 as WO 2021/122731 A1 under PCT Article 21(2).

### FIELD

The present disclosure relates to a contamination protection for the edges of riblet films which are adhesively bonded to a surface.

### BACKGROUND

Riblet structures are microstructures of surfaces that reduce the friction resistance for fluids flowing along the surface—the so-called wall friction. Corresponding structures are in principle advantageous for such applications, in which the wall friction represents a considerable proportion of the flow-related overall resistance. Thus, riblet structures are found, for example, on outer surfaces of aircraft, but also on rotor blades of wind turbines, on the outer skin of ships or on outer surfaces of high-speed trains. Such structures are also used, for example, on inner surfaces of pipelines.

As a result of corresponding riblet structures, therefore, the wall friction and consequently also the overall air resistance of an aircraft in flight can be reduced, which inter alia, leads to lower fuel costs. This applies to other applications of riblet structures in a comparable manner.

There are various possibilities for how riblet structures can be applied to already existing structures, such as, for example, the painted outer skin of aircraft. For example, riblet structures in the form of a self-adhesive riblet film can be applied to a structure. The riblet film with riblets on one side and an adhesive layer on the other side can, in principle, be adhesively bonded to any surface. The riblet film can in this instance be cut to the required size. It is also possible for the riblet film to further comprise other layers in addition to the film layer with riblet structures arranged thereon and the adhesive layer. For example, a film layer which originally has no adhesive layer and which comprises riblet structures with a dual-sided adhesive strip can be applied to a surface, whereby another carrier layer and an inner adhesive layer are added to the two layers mentioned. A possible structure of a riblet film may also have the layer structure adhesive layer, carrier film, adhesive layer, paint with a riblet structure impressed therein.

It has been found that the edges of riblet films which are adhesively bonded to surfaces as a result of dirt become discolored over time so that the outlines of riblet films are very evident. This is generally undesirable.

With decorative films on surfaces which are flowed over, comparable occurrences of contamination can be seen. In order to reduce this contamination and the associated negative visual impression, so-called edge sealers may be used, in which the edge of the film is covered with a curable gel which can be removed with solvent so that an edge-free transition is produced between the surface and film. However, the edge sealer also expands the film, which is acceptable with decorative films but, with aerodynamically functional films, such as riblet films, as a result of disruptions of the overflow brought about by means of an edge sealer, reduces the efficiency thereof.

### SUMMARY

In an embodiment, the present disclosure provides a contamination protection that is for edges of a riblet film, which is adhesively bonded to a surface. The riblet film has riblets formed on an upper side of a film layer, and an adhesive layer at a lower side of the film layer. The contamination protection has: an edge protection, the edge protection being formed directly on the riblet film that is adhesively bonded to the surface in such a manner that the edge protection covers the adhesive layer of the riblet film, but does not protrude over the upper side of the riblet film.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a riblet film which is adhesively bonded to a surface;

FIGS. 2a, b show the riblet film from FIG. 1 with a first embodiment of a contamination protection according to the present disclosure;

FIG. 3 shows a schematic illustration of an application apparatus for the contamination protection from FIG. 2;

FIGS. 4a, b show the riblet film from FIG. 1 with a first embodiment of a contamination protection according to the present disclosure;

FIG. 5 shows a schematic illustration of an application apparatus for the contamination protection from FIG. 4; and

FIG. 6 shows a schematic illustration of the contamination protection according to the present disclosure according to FIG. 4 in two riblet films which are arranged close beside each other.

### DETAILED DESCRIPTION

One or more aspects of the present disclosure provide a contamination protection that is suitable for the edges of riblet films that are adhesively-bonded to a surface.

Accordingly, the present disclosure relates to a contamination protection for the edges of riblet films that are adhesively bonded to a surface with riblets that are formed on the upper side of a film layer and an adhesive layer at the lower side, comprising an edge protection which is formed directly on a riblet film which is adhesively bonded to a surface in such a manner that the edge protection covers the adhesive layer of the riblet film but does not protrude over the upper side of the riblet film.

The present disclosure has recognized that, for the accumulation of dirt at the edge of riblet films on surfaces which are flowed over, such as, for example, the outer skin of aircraft, it is not the presence of the step or edge which is necessarily provided by the riblet film with respect to the surface to which it is adhesively bonded which is significant, but instead the adhesive layer which is provided for adhesively bonding the film to the edge of a riblet film being exposed so that particles of dirt permanently bond thereto. The same applies to any other internal adhesive layers of the riblet film which are also exposed at the edge of a riblet film. For reasons of readability, however, reference is made below only to the adhesive layer for securing the riblet film to a surface. However, the corresponding embodiments also apply in a similar manner to any additional adhesive layers which can be covered together with the above-mentioned adhesive layer.

By there being provided, according to an aspect of the present disclosure, at the edge of the riblet film, an edge protection that adjoins the adhesive layer of the riblet film and covers it, an adhesion of dirt to the adhesive layer is prevented. At the same time, the edge protection according to an aspect of the present disclosure—in contrast to known edge sealers—does not protrude beyond the upper side of the riblet film and in particular also does not extend on the upper side of the film layer. Consequently, the flow over the riblet film and the efficiency thereof is practically not impaired.

It is preferable for the edge protection to be formed from small-grained to powdered granulate whose particles adhere to the adhesive layer of the riblet film. Ultimately, therefore, the relationship, which in the prior art leads to the adhesion of dirt to the edges of a riblet film, is used in order to fix granulate particles to the edge of the riblet film. If the adhesive layer at the edge of the riblet film is completely covered by the granulate, particles of dirt can no longer adhere there.

As an alternative to the use of a granulate, the edge protection may also be formed from a cured fluid which has sufficient adhesion thereto for bonding to the adhesive layer of the riblet film. The cured fluid may in this instance lie as a film over the exposed side of the adhesive layer at the edge of the riblet film and can thus prevent the undesirable adhesion of dirt particles thereto. In this instance, it continues to be the case that the edge protection formed by the cured fluid does not protrude over the upper side of the riblet film and in particular does not adjoin the upper side of the film layer of the riblet film. This can preferably be ensured by the fluid used at least in the fluid state having no or hardly any adhesion to the film layer itself so that it does not itself already adhere to the film layer during curing or at least after completed curing can be simply removed from the film layer itself.

The fluid can be selected in such a manner that it bonds not only to the adhesive layer of the riblet film, but also to the surface on which the riblet film is bonded. The in principle step-like transition from the surface to the riblet film can then be formed in an aerodynamically improved manner by the inner corner being filled at the transition from the surface to the side of the riblet film. In this instance, the edge protection continues not to protrude over the upper side of the riblet film.

Regardless of how the edge protection according to an aspect of the present disclosure is formed, it is preferably transparent, for which reason, for example, the granulate particles or the fluid may be transparent in the cured state. By the edge protection itself being transparent, it can be formed on riblet films of different colors without disrupting the visual appearance of the combination of the riblet film and surface.

In order to apply the edge protection according to an aspect of the present disclosure, there can be used an application apparatus, which can be guided along an edge of a riblet film and which has a supply opening for edge protection material. The edge protection material may, for example, be small-grained to powdered granulate or a curable fluid.

In this instance, it is preferable for the application apparatus to have a height limitation by means of which the maximum height of the edge protection material over the surface during application is limited to a height which is less than or equal to the height of the upper side of the riblet film or to the thickness of the adhesive layer of the riblet film. As a result of a corresponding height limitation, it can already be ensured when the edge protection according to an aspect of the present disclosure is applied that the edge protection in the formed state does not protrude over the riblet film.

Furthermore, an extraction unit for excess edge protection material may be provided in the application apparatus. By excess edge protection material being extracted, it can be ensured that it does not settle and potentially cure at undesirable locations.

The application apparatus may further have a curing device, preferably a UV lamp, for curing the edge protection material. Fluids which require light of a specific wavelength for curing can thus be cured directly during application.

It has been found that the edge protection according to an aspect of the present disclosure when applied to opposing edges of two adjacent riblet films which are arranged close to each other can improve the aerodynamic properties of the transition between the two riblet films by the gap between the two riblet films being at least partially filled by the edge protection.

The present disclosure will now be described by way of example with reference to advantageous embodiments and the appended drawings.

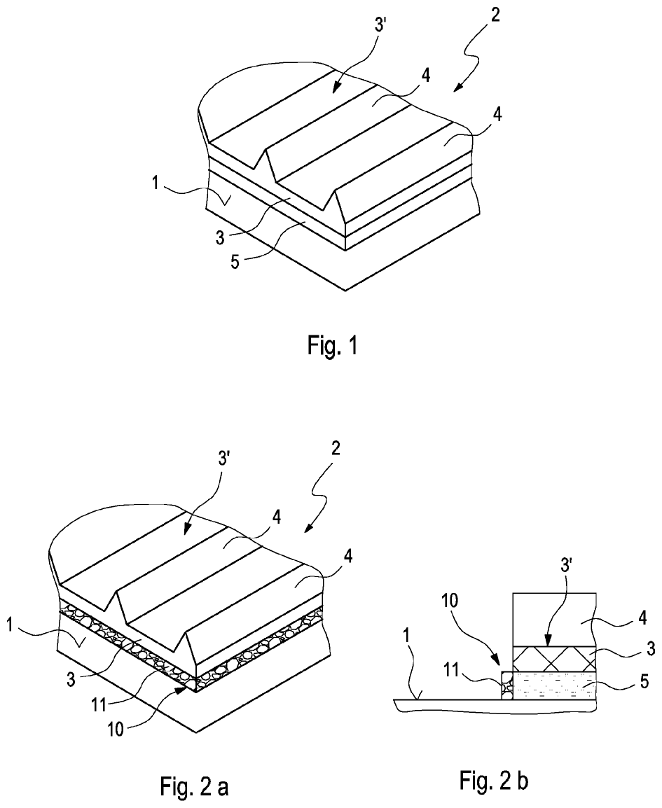

FIG. 1 shows a riblet film 2 which is adhesively bonded to a surface 1. The riblet film 2 comprises in this instance riblets 4 which are formed at the upper side 3′ of a film layer 3, whilst the lower side of the film layer 3 is provided with an adhesive layer 5 in order to apply the riblet film 2 to the surface 1 in a materially engaging manner. As can be seen in FIG. 1, the adhesive layer 5 is exposed at the edges of the riblet film 2.

FIG. 2 shows a first embodiment of a contamination protection 10 according to an aspect of the present disclosure for the riblet film 2 from FIG. 1. FIG. 2a shows in this instance a schematic isometric view, whilst FIG. 2b shows a schematic cross section.

The contamination protection 10 comprises an edge protection 11 which is formed from powdered transparent granulate. The granulate is in this instance formed on the riblet film 2 in such a manner that it adhesively bonds to the adhesive layer 5 thereof and completely covers it. The connection is carried out in this instance simply as a result of the adhesive action of the adhesive layer 5—the granulate itself is not adhesive. Since in the embodiment the adhesive layer 5 is completely covered by the granulate, as a result no more contamination can bond to the adhesive layer 5. At the same time, it is inherent in this embodiment that the edge protection 10 does not protrude over the upper side 3′ of the film layer 3 and consequently the riblet film 2.

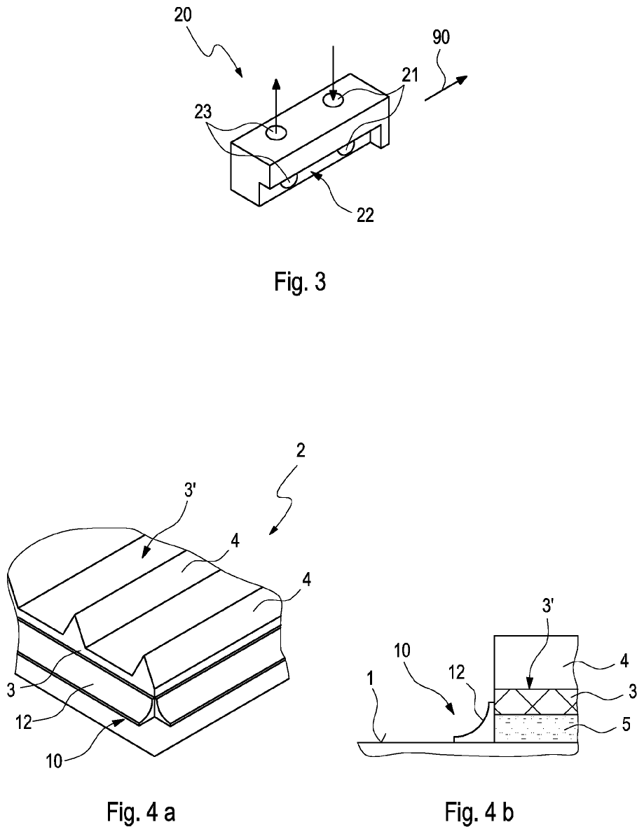

FIG. 3 shows a possible application apparatus 20 for producing the contamination protection according to FIG. 2. The application apparatus 20 is in this instance guided in the direction indicated by the arrow 90 along the edge of a riblet film 2, such as, for example, from FIG. 1. In this instance, granulate is introduced through a first opening 21 into a workspace 22 which in the state of use of the application apparatus 20 is additionally further delimited by the surface 1 and the edge of the riblet film 2. Within the workspace 22, the granulate consequently comes into contact with the adhesive layer 5 of the riblet film 2 and is adhesively bonded at that location. The granulate which during the slow movement of the application apparatus 20 along the edge of the riblet film 2 does not bond to the adhesive layer 5 is extracted via the opening 23 and can, for example, be reused.

FIG. 4 shows a second embodiment of a contamination protection 10 according to an aspect of the present disclosure for the riblet film 2 from FIG. 1. The views in FIGS. 4a, b correspond in this instance to those of FIGS. 2a, b.

In this embodiment, the contamination protection 10 comprises an edge protection 12 which is formed from a curable fluid—in the embodiment illustrated, a UV curable gel. The edge protection 12 in this instance fully covers the adhesive layer 5 of the riblet film 2 and also overlaps slightly with the film layer 3 (cf. FIG. 4b). Nonetheless, the edge protection 12 does not protrude over the upper side 3′ of the film layer 2 and consequently the riblet film 2. The edge protection 12 further has a shape which promotes flow and is transparent at least in the cured state.

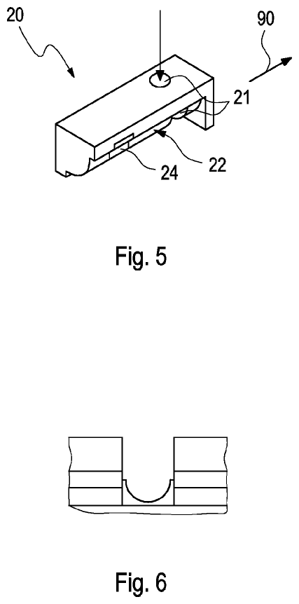

FIG. 5 shows an exemplary application apparatus 20 for the contamination protection 10 according to FIG. 4. The application apparatus 20 is in this instance guided in the direction indicated by the arrow 90 along the edge of a riblet film 2, as, for example, in FIG. 1, whereby a workspace 22 is formed by the application apparatus 20, the surface 1 and the edge of the riblet film 2 which represents a negative form of the desired edge protection 12, whereby a height limitation starting from the surface 1 up to which the fluid can accumulate is also produced. The fluid which is intended to be cured is introduced into the workspace 22 through a supply opening 21 and by moving the application apparatus 20 in the direction 90 is guided past the curing device 24 which is integrated in the application apparatus 20—a UV lamp, whereby the fluid is cured in the predetermined form.

FIG. 6 schematically illustrates how the edges of two riblet films 2 which are directly adjacent on a surface 1 can be protected from contamination. In the embodiment illustrated, the region between the two riblet films 2 is filled with a material which is identical to the edge protection 12 from FIG. 4 to this end, wherein the edge protection in this instance also covers the respective adhesive layer 5 of the riblet films 2, but does not protrude over the upper sides 3′ of the riblet films 2. By the intermediate space between the two riblet films 2 being partially filled by the edge protection 12, the flow over the transition between the two riblet films 2 can also be improved.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A contamination protection for edges of a riblet film, which is adhesively bonded to a surface, the riblet film having riblets formed on an upper side of a film layer, and an adhesive layer at a lower side of the film layer, the contamination protection comprising:
an edge protection, the edge protection being formed directly on the riblet film that is adhesively bonded to the surface in such a manner that the edge protection covers the adhesive layer of the riblet film, but does not protrude over the upper side of the riblet film.

2. The contamination protection as claimed in claim 1,
wherein the edge protection is formed from small-grained to powdered granulate whose particles adhere to the adhesive layer of the riblet film.

3. The contamination protection as claimed in claim 1,
wherein the edge protection is formed from a cured fluid which has a good adhesion to the adhesive layer of the riblet film.

4. The contamination protection as claimed in claim 0,
wherein the cured fluid bonds to the surface.

5. The contamination protection as claimed in claim 1,
wherein the edge protection is transparent.

6. An application apparatus for the contamination protection as claimed in claim 1, which is configured to be guided along an edge of the riblet film and which has a supply opening for the edge protection, which comprises an edge protection material.

7. The application apparatus as claimed in claim 0,
wherein there is provided a height limitation by which a maximum height of the edge protection material over the surface during application is limited to a height which is less than or equal to a height of the upper side of the riblet film or to a thickness of the adhesive layer of the riblet film.

8. The application apparatus as claimed in claim 0,
wherein an extraction unit is provided for excess edge protection material.

9. The application apparatus as claimed in claim 6,
comprising a curing device configured to cure the edge protection material.

10. The contamination protection as claimed in claim 3,
wherein the edge protection is formed from the cured fluid which, at least in a fluid state, has no adhesion to the film layer.

11. The application apparatus as claimed in claim 9,
wherein the curing device is a UV lamp.
